(19) United States
(12) Patent Application Publication
(10) Pub. No.: US 2007/0287449 A1
(43) Pub. Date: Dec. 13, 2007

(54) METHOD FOR TRANSMITTING COMMON CONTROL INFORMATION IN A WIRELESS MOBILE COMMUNICATION SYSTEM

(75) Inventors: Hyeong-Jong JU, Suwon-si (KR); Min-Hee Cho, Suwon-si (KR); Jang-Hoon Yang, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/760,309

(22) Filed: Jun. 8, 2007

(30) Foreign Application Priority Data
Jun. 9, 2006 (KR) 51920-2006

(51) Int. Cl. H04Q 7/20

(52) U.S. Cl. 455/433

(57) ABSTRACT

A method for transmitting common control information from a Base Station (BS) to an Mobile Station (MS) in a wireless mobile communication system is provided, in which the BS generates a MAP Information Element (IE) using common control information to be transmitted to the MS, the common control information being resource allocation information and control information, converts the MAP IE to a MAP IE message, applies an Modulation and Coding Scheme (MCS) level corresponding to the channel status of the MS, and transmits the MAP IE message with data to the MS.

### PRIORITY

This application claims priority under 35 U.S.C. §119(a) to a Korean Patent Application filed in the Korean Intellectual Property Office on Jun. 9, 2006 and assigned Serial No. 2006-51920, the entire disclosure of which is hereby incorporated by reference.

### BACKGROUND OF THE INVENTION

1. Field of the Invention

The present invention generally relates to a method for managing resources in a wireless mobile communication system. More particularly, the present invention relates to a method for transmitting common control information in a wireless mobile communication system.

2. Description of the Related Art

Providing services with diverse Quality of Service (QoS) requirements at or above 100 Mbps to users is an active study area for a future-generation communication system, known as a 4th Generation (4G) communication system. Particularly, active research is conducted on providing high-speed service by ensuring mobility and QoS to a Broadband Wireless Access (BWA) communication system such as Wireless Local Area Network (WLAN) and Wireless Metropolitan Area Network (WMAN). A major example of such a system is an Institute of Electrical and Electronics Engineers (IEEE) 802.16 communication system.

FIG. 1 illustrates a configuration of a typical IEEE 802.16 communication system. The IEEE 802.16 communication system ensures a mobility of Subscriber Stations (SSs) and thus it is deployed in a multi-cell structure. Such cells as illustrated in FIG. 1 are neighboring to one another in the IEEE 802.16 communication system.

Referring to FIG. 1, the communication system includes a Base Station (BS) 101 that covers a cell 100 and a plurality of Mobile Stations (MSs) 103, 105, 107, 109, and 111 (referred to as MS1 to MS5, respectively) that receive a communication service from the BS 101. Signaling can be carried out in Orthogonal Frequency Division Multiplexing (OFDM)/Orthogonal Frequency Division Multiple Access (OFDMA) between the BS101 and MS1 to MSS.

In the wireless mobile communication system, data is transmitted in frames, each being divided into a MAP area with control information and resource allocation information, a DownLink (DL) burst area, and an UpLink (UL) burst area. The BS transmits the resource allocation information to the MSs by MAP messages, DL-MAP and UL-MAP. The DL-MAP message and the UL-MAP message have the following configurations described in Table 1 and Table 2 below, respectively:

TABLE 1

| Syntax | Size (bits) | Notes |
|---|---|---|
| DL-MAP_Message_Format( ) { | | |
| Management Message Type=2 | 8 | |
| PHY Synchronization Field | Variable | See appropriate PHY |
| | | specification |
| DCD Count | 8 | |
| Base Station ID | 48 | |
| Begin PHY Specific Section { | | See applicable PHY |
| | | subclause |
| if (Wireless MAN-OFDMA) { | | |
| No. OFDMA symbols | 8 | Number of OFDMA |
| | | symbols in the DL |
| | | subframe including all |
| | | AAS/permutation zone |
| } | | |
| for (i=1;i<=n;i++) { | | For each DL-MAP |
| | | element 1 to n |
| DL-MAP_IE( ) | variable | See corresponding PHY |
| | | specification |
| } | | |
| } | | |
| if ! (byte boundary) { | | |
| Padding Nibble | 4 | Padding to reach byte |
| | | boundary |
| } | | |
| } | | |

TABLE 2

| Syntax | Size (bits) | Notes |
|---|---|---|
| UL-MAP_Message_Format( ) { | | |
| Management Message Type=3 | 8 | |
| Reserved | 8 | Shall be set to zero |
| UCD Count | 8 | |
| Allocation Start Time | 32 | |
| Begin PHY Specific Section { | | See applicaple PHY |
| | | subclause |
| if (Wireless MAN-OFDMA) { | | |
| No. OFDMA symbols | 8 | Number of OFDMA |
| | | symbols in |
| | | the UL subframe |
| } | | |
| for (i=1;i<=n;i++) { | | For each UL-MAP |
| | | element 1 to n |
| UL-MAP_IE( ) | variable | See corresponding PHY |
| | | specification |
| } | | |
| } | | |
| if ! (byte boundary) { | | |
| Padding Nibble | 4 | Padding to reach byte |
| | | boundary |
| } | | |
| } | | |

The BS transmits DL and UL resource allocation information by the DL-MAP and UL-MAP messages. The MSs detect control information and information about the locations of resources allocated to them by decoding the DL-MAP and UL-MAP messages. Thus, the. MSs are capable of transmitting/receiving DL or UL data using the detected information.

During data transmission/reception, the MSs are placed in different channel statuses, i.e. different propagation environments due to obstacles or propagation interference between the BS and the MSs. Therefore, the BS adaptively selects a Modulation and Coding Scheme (MCS) level for each of the MSs, according to the channel status of the MS.

MCS levels are combinations of modulation and coding, and range from level 1 to level N according to the number of available MCSs. MCS levels are adaptively selected according to the channel statuses between the BS and the MSs. In case of a good channel status between the BS and an MS, the BS may select a high MCS level specifying 64-ary Quadrature Amplitude Modulation (64 QAM) and a code rate 5/6 for the MS. In case of a poor channel status between the BS and the MS, the BS may select a low MCS level specifying Quadrature Phase Shift Keying (QPSK) and a code rate 1/12 for the MS.

Assuming MS1 103 is in the best channel status and MS5 111 is in the poorest channel status in FIG. 1, the BS 101 selects MCS levels based on channel status information received from MS1 103 and MS5 111 and transmits data encoded and modulated using the selected MCS levels to MS1 103 and MS5 111. MS1 103 and MS5 111 have different resource requirements according to their channel statuses. Hence, the BS 101 allocates required resources to them through MCS level selection. In general, the least resources are allocated to the MS in the best channel status and the most resources to the MS in the poorest channel status.

MAP information including system information and resource allocation information is so significant that MSs must receive the, MAP information. That's why the BS 101 transmits the MAP information using the most robust MCS level. For the same amount of information, a lower MCS level requires a larger amount of resources. That is, the MAP information requires the same or more resources in amount, compared to data transmitted to each MS. However, every MS may not need receive the MAP information because a certain MAP IE is destined for a particular MS or some MSs. Consequently, use of a large amount of radio resources for the MAP IE (Information Element) decreases radio resource utilization.

### SUMMARY OF THE INVENTION

An aspect of the present invention is to address at least the problems and/or disadvantages and to provide at least the advantages described below. Accordingly, an aspect of exemplary embodiments of the present invention is to provide a method for efficiently managing radio resources in a wireless mobile communication system.

In accordance with an aspect of the present invention, there is provided a method for transmitting common control information to an MS in a BS in a wireless mobile communication system, in which the BS generates a MAP IE using common control information to be transmitted to the MS, the common control information being resource allocation information and control information, converts the MAP IE to a MAP IE message, applies an MCS level corresponding to the channel status of the MS, and transmits the MAP IE message with data to the MS.

In accordance with another aspect of the present invention, there is provided a method for receiving common control information from a BS in an MS in a wireless mobile communication system, in which the MS receives a data burst IE associated with data burst allocation from the BS, decodes a data burst using the data burst IE, and detects a MAP IE message including common control information during the decoding, the common control information being resource allocation information and control information.

### BRIEF DESCRIPTION OF THE DRAWINGS

The above and other objects, features, and advantages of certain exemplary embodiments of the present invention will be more apparent from the following detailed description taken in conjunction with the accompanying drawings, in which:

FIG. 1 illustrates the configuration of a typical IEEE 802.16 communication system;

FIG. 2 illustrates the format of a Medium Access Control (MAC) management message in a wireless mobile communication system according to the present invention;

FIG. 3 is a flowchart illustrating a MAP IE transmission operation in a BS according to the present invention;

FIG. 4 is a flowchart illustrating a MAP IE reception operation in an MS according to present invention; and

FIGS. 5A and 5B illustrate exemplary data burst structures and MAP IEs according to the present invention.

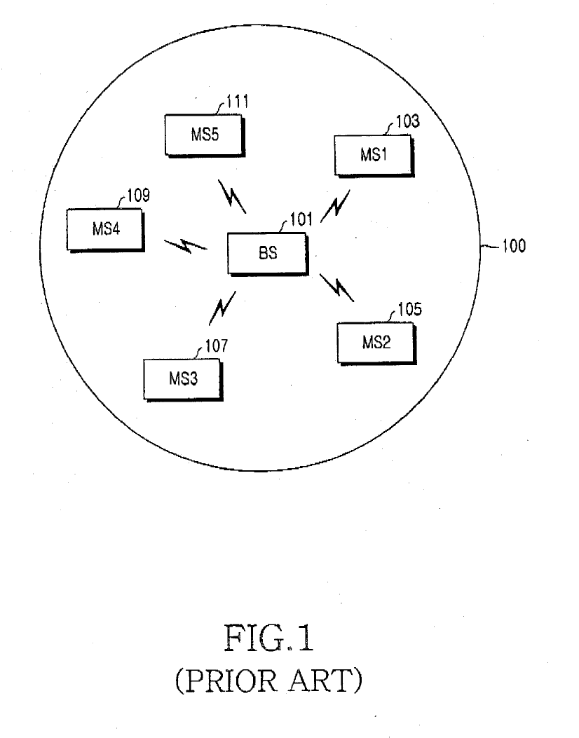

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention discloses a method for transmitting MAP information in the form of a message in a wireless mobile communication system. This message is a MAC (Medium Access Control) management message. Transmission of the MAP information in the form of the message requires fewer resources than transmission of the MAP information in a MAP area because the BS converts the MAP information to the message prior to transmission under the assumption that it already has knowledge of the channel status of the MS. The MAP information includes control information and resource allocation information and will be referred to as common control information hereinbelow.

The present invention is applicable to any wireless mobile communication system using a DL-MAP IE and a UL-MAP IE.

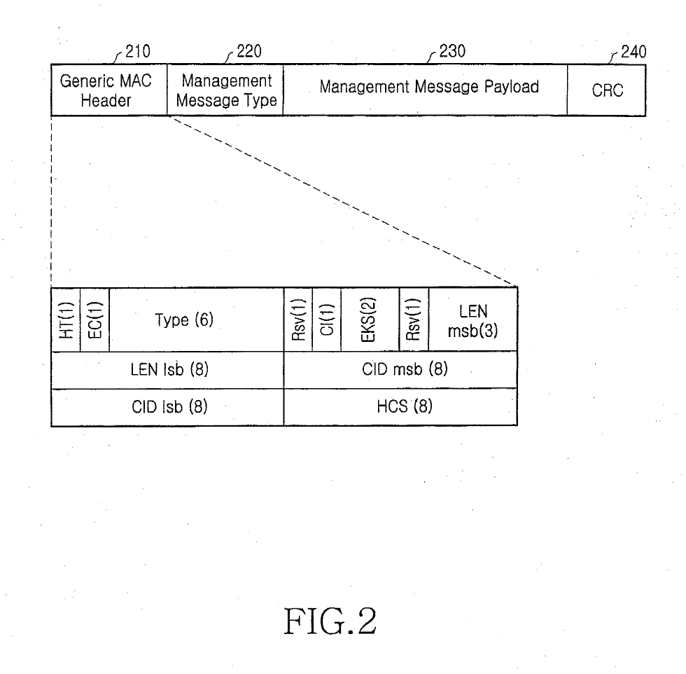

FIG. 2 illustrates the format of a MAC management message in a wireless mobile communication system according to the present invention.

Referring to FIG. 2, a BS exchanges information with an MS through MAC management messages. The MAC management messages each include a 6-byte Generic MAC Header field 210, a 1-byte Management Message Type field 220, a variable-length Management Message Payload 230 field, and a 4-byte Cyclic Redundancy Check (CRC) field 240.

The Generic MAC Header field 210 is composed of a Header Type (HT) field, an Encryption Control (EC) field indicating whether data is encrypted, a Type field indicating whether a subheader exists, a CI (CRC Indicator) field indicating the presence or absence of the CRC field, an Encryption Key Sequence (EKS) field, a Length field indicating the total length of the MAC management message, a Connection IDentifier (CID) field, and a Header Check Sequence (HCS) field for use in checking link errors of the Generic MAC Header 210.

The Management Message Type field 220 contains an ID identifying the usage of a new DL-MAP IE/UL-MAP IE message proposed according to the present invention. These new DL-MAP IE and UL-MAP IE messages are defined in Table 3 below.

TABLE 3

| | | Message | |
|---|---|---|---|
| Type | Message Name | Description | Connection |
| TBD (To Be | DL-MAP IE | Downlink Access | Broadcasting or |
| Determined) | Message | Definition | Basic CID |
| TBD | UL-MAP IE | Uplink Access | Broadcasting or |
| | Message | Definition | Basic CID |

Unlike the conventional MAP information transmission in the MAP area, the DL-MAP IE message and the UL-MAP IE message described in Table 3 are transmitted along with DL data in the present invention. If the DL-MAP IE message and the UL-MAP IE message are directed to one MS, they can be transmitted using a basic CID specific to the MS.

Table 4 and Table 5 illustrate the formats of the DL-MAP IE message and the UL-MAP IE message, respectively.

TABLE 4

| Syntax | Size (bits) | Notes |
|---|---|---|
| DL-MAP-IE_Message_Format( ) | | |
| { | | |
| Management Message | 8 | |
| Type=?? | | |
| for (i=1;i<=n;i++) { | | For each DL-MAP |
| | | element 1 to n |
| DL-MAP_IE( ) | variable | See corresponding PHY |
| | | specification |
| } | | |
| if ! (byte boundary) { | | |
| Padding Nibble | 4 | Padding to reach byte |
| | | boundary |
| } | | |
| } | | |

Preferably but not necessarily, the length in bytes of the DL-MAP IE message is an integer. If the DL-MAP IE message does not have an integer number of bytes, some bits must be padded in the message and the MS must neglect the padding.

TABLE 5

| Syntax | Size (bits) | Notes |
|---|---|---|
| UL-MAP-IE_Message_Format( ) | | |
| { | | |
| Management Message | 8 | |
| Type=?? | | |
| for (i=1;i<=n;i++) { | | For each UL-MAP |
| | | element 1 to n |
| UL-MAP_IE( ) | variable | See corresponding PHY |
| | | specification |
| } | | |
| if ! (byte boundary) { | | |
| Padding Nibble | 4 | Padding to reach byte |
| | | boundary |
| } | | |
| } | | |

As with the UL-MAP IE message, preferably but not necessarily, the length in bytes of the UL-MAP IE message is an integer. If the UL-MAP IE message does not have an integer number of bytes, some bits must be padded in the message and the MS must neglect the padding.

When transmitting a particular UL burst IE in the UL-MAP IE message, the BS must notify the MS of the absolute position of the UL burst IE in a UL burst area. It is because the MS cannot receive every UL burst IE in a frame, which means that the MS cannot determine the accurate position of the UL burst IE.

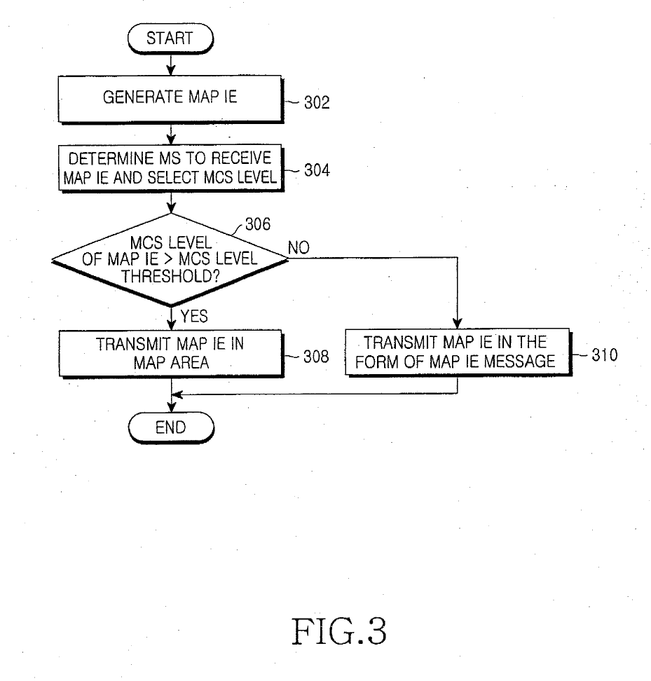

FIG. 3 is a flowchart illustrating a MAP IE transmission operation in a BS according to the present invention.

Referring to FIG. 3, the BS generates a MAP IE in step 302. The MAP IE is a DL-MAP IE or a UL-MAP IE and can be directed to one or more MSs. In step 304, the BS determines an MS to receive the MAP IE, selects an MCS level according to the channel status of the MS, and applies the MCS level to the MAP IE.

In step 306, the BS compares the MCS level of the MAP IE with a predetermined MCS level threshold. If the MCS level of the MAP IE is less than or equal to the MCS level threshold, the BS goes to step 308. If the MCS level of the MAP IE is greater than the MCS level threshold, the BS proceeds to step 310.

In step 308, the BS transmits the MAP IE in the MAP area to the MS. In step 310, the BS converts the MAP IE to a message and transmits the message to the MS.

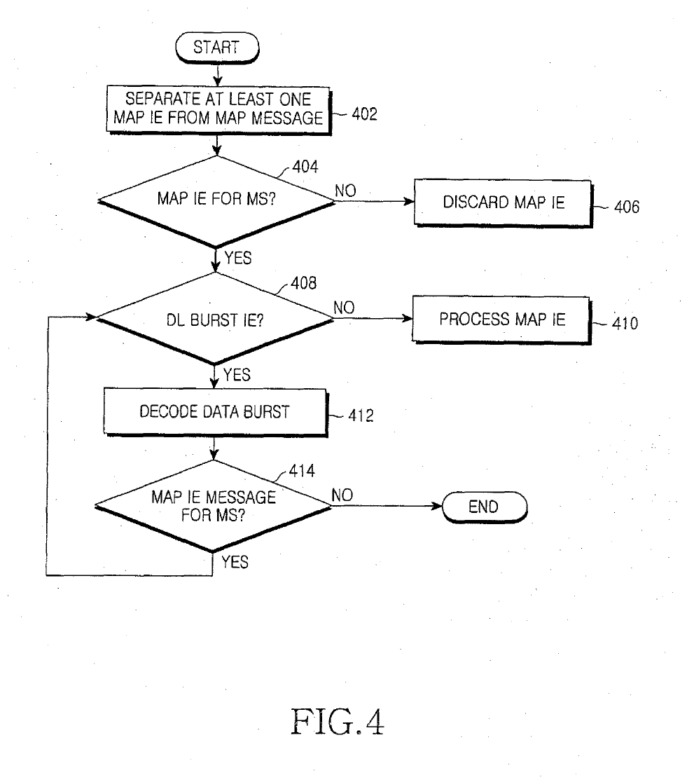

FIG. 4 is a flowchart illustrating a MAP IE reception operation in an MS according to the present invention.

Referring to FIG. 4, the MS separates at least one MAP IE from a MAP message received from the BS in step 402. The MAP message is a DLFUL-MAP message or a compressed MAP message with the DL-MAP message and the UL-MAP message in combination. The MAP message may contain at least one MAP IE. In step 404, the MS determines whether it is supposed to receive and process the MAP IE by checking a CID included in the MAP IE. If the CID of the MS is present in the MAP IE, the MS receives and processes the MAP IE. If a broadcasting CID exists instead of the CID in the MAP IE, which means that the MAP IE is directed to all MSs, the MS receives and processes the MAP IE. In this manner, the MS detects a MAP IE to receive and process referring to a CID in the MAP IE. Meanwhile, if the MS determines that it is not supposed to receive and process the MAP IE, it discards the MAP IE in step 406.

In step 408, the MS determines whether the MAP IE to receive and process is a DL burst IE associated with data burst allocation. If the MAP IE is a DL burst IE, the MS goes to step 412. If the MAP IE is not a DL burst IE, the MS processes the MAP IE in step 410. The MS decodes a data burst indicated by the DL burst IE in step 412 and determines whether the data burst includes a MAP IE message proposed by the present invention, i.e. a DL-MAP IE message or a UL-MAP IE message in step 414. To make this determination, the MS checks the CID field of the Generic MAC Header 210 of the MAP IE message. For example, if a broadcasting CID or the ID of the MS is filled in the CID field, the MS processes the MAP IE message. In the presence of the MAP IE message for the MS, the MS returns to step 408 and otherwise, it ends the algorithm of the present invention.

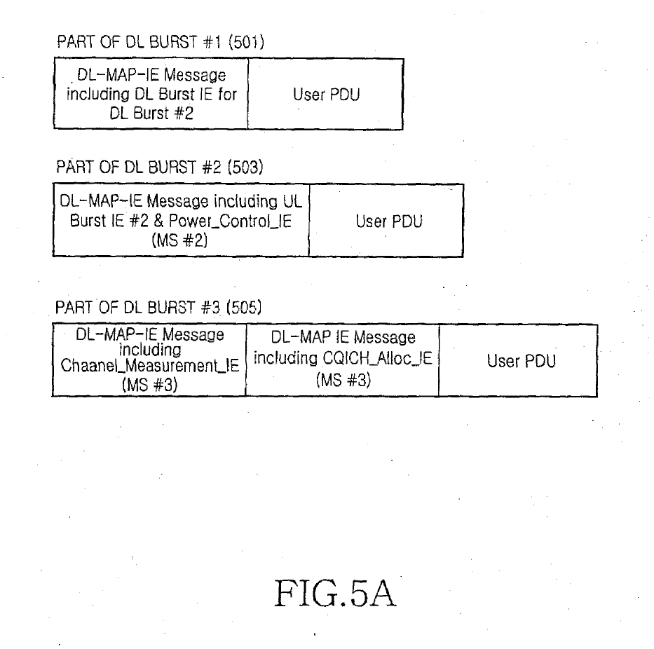

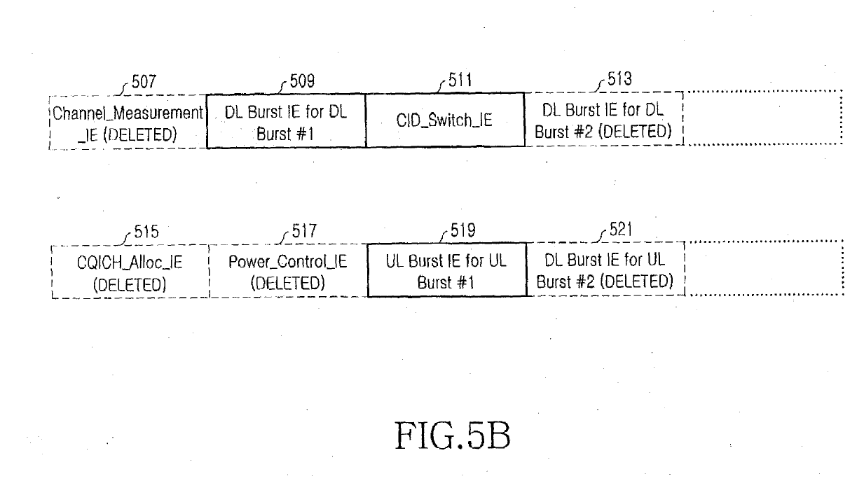

FIGS. 5A and 5B illustrate exemplary data burst structures and MAP IEs according to the present invention.

The BS selects a MAP IE from among a plurality of MAP IEs, for transmission along with a data burst, converts the MAP IE in the form of a message, and transmits the MAP IE message to the MS. Therefore, the same MCS level is applied to both the MAP IE message and the data burst.

Referring to FIG. 5A, a first DL burst 501 (DL burst #1) is for MS1 but includes a DL-MAP IE message with a DL burst IE for MS2. A second DL burst 503 (DL burst #2) is for MS2 and includes a DL-MAP IE message with an UL-Burst_IE and a Power_Control_IE for MS2.

A third DL burst 505 (DL burst #3) is for MS3. DL burst #3 505 includes a DL-MAP IE message with a Channel_Measurement IE for MS3 and a UL-MAP IE message with a Channel Quality Information CHannel (CQICH)_Alloc_IE for MS3.

FIG. 5B illustrates DL-MAP TEs and UL-MAP IEs. Conventionally, all IEs are transmitted in the MAP areas. Thus, a Channel_Measurement IE 507, a DL burst IE for DL burst #1 509, a CID_Switch_IE 511, a DL burst IE for DL burst #2 513, a CQICH_Alloc_IE 515, a Power_Control_IE 517, a UL burst IE for UL burst #1 519, and a UL burst IE for UL burst #2 521 are included in MAP messages.

However, in accordance with the present invention, some TEs 507, 513, 515, 517 and 521 are converted to MAC management messages and transmitted in data bursts, as illustrated in FIG. 5A. Therefore, radio resources are efficiently utilized.

For example, MSs decode a DL-MAP message and acquire allocation information about DL burst #1 501. It is assumed herein that DL burst #1 501 is directed to all MSs. Hence, MS2 decodes DL burst #1 501 and is aware that DL burst #1 501 includes a DL-MAP IE message for MS2. Thus, MS2 acquires information with which to decode DL burst #2 503 using the DL-MAP IE message.

MS2 decodes DL burst #2 503 and recognizes that it includes a UL-MAP IE message with a Power_Control_IE 517. MS2 then processes the UL-MAP IE message so as to transmit a UL burst and changes uplink power as indicated by the Power_Control_IE 517.

In the same manner, MS3 processes the DL-MAP message or a DL-MAP IE message included in a data burst. Thus, MS3 decodes DL burst #3 505 and is aware that the DL burst #3 505 includes a DL-MAP IE message with a Channel_Measurement_IE and a UL-MAP IE message with a CQICH_Alloc_IE. Thus, MS3 reports a channel measurement to the BS on a feedback channel indicated by the Channel_Measurement_IE.

In accordance with the present invention as described above, a BS converts MAP IEs to MAC IE messages and transmits them in data bursts, compared to conventional transmission of the MAP IEs in a MAP area. Therefore, while the lowest MCS level is applied to the MAP IEs in the conventional technology, the MAP IE messages are encoded and modulated using MCS levels that are selected according to the channel statuses of MSs. Consequently, radio resources are saved.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. A method for transmitting common control information to a Mobile Station (MS) in a Base Station (BS) in a wireless mobile communication system, comprising:
generating a MAP Information Element (IE) using common control information to be transmitted to the MS, the common control information being resource allocation information and control information;
converting the MAP IE to a MAP IE message; and
applying a Modulation and Coding Scheme (MCS) level corresponding to a channel status of the MS and transmitting the MAP IE message with data to the MS.

2. The method of claim 1, wherein the conversion comprises:
comparing the MCS level corresponding to the channel status of the MS with a system-preset MCS level threshold; and
converting the MAP IE to the MAP IE message, if the MCS level exceeds the MCS level threshold.

3. The method of claim 1, wherein the MAP IE message includes a broadcasting Connection IDentifier (CID) common to a plurality of MSs.

4. The method of claim 1, wherein the MAP IE message includes a basic CID specific to the MS.

5. A method for receiving common control information from a Base Station (BS) in a Mobile Station (MS) in a wireless mobile communication system, comprising:
receiving a data burst Information Element (IE) associated with data burst allocation from the BS;
decoding a data burst using the data burst IE; and
detecting a MAP IE message including common control information during the decoding, the common control information being resource allocation information and control information.

6. The method of claim 5, wherein the data burst BE is included in a MAP message transmitted in a MAP area of a frame.

7. The method of claim 5, wherein the MAP IE message is associated with a channel status measurement.

8. The method of claim 5, wherein the MAP IE message is associated with channel allocation information for reporting channel quality information.

9. The method of claim 5, wherein the MAP IE message is associated with an uplink power control.

10. The method of claim 5, wherein the MAP IE message is associated with an uplink data burst allocation.

11. The method of claim 5, wherein the MAP IE message is associated with a downlink data burst allocation.
